(19) United States
(12) Patent Application Publication
(10) Pub. No.: US 2010/0202656 A1
(43) Pub. Date: Aug. 12, 2010

(54) Ultrasonic Doppler System and Method for Gesture Recognition

(76) Inventors: Bhiksha Raj Ramakrishnan, Pittsburgh, PA (US); Kaustubh Kalgaonkar, Atlanta, GA (US)

Correspondence Address: MITSUBISHI ELECTRIC RESEARCH LABORATORIES, INC., 201 BROADWAY, 8TH FLOOR, CAMBRIDGE, MA, 02139, US

(21) Appl. No.: 12/367,720

(22) Filed: Feb. 9, 2009

(51) Int. Cl. G06K 9/00

(52) U.S. Cl. 382/103

(57) ABSTRACT

A method and system recognizes an unknown gesture by directing an ultrasonic signal at an object making an unknown gestures. A set of Doppler signals are acquired of the ultrasonic signal after reflection by the object. Doppler features are extracted from the reflected Doppler signal, and the Doppler features are classified using a set of Doppler models storing the Doppler features and identities of known gestures to recognize and identify the unknown gesture, wherein there is one Doppler model for each known gesture.

### FIELD OF THE INVENTION

This invention relates generally to gesture recognition, and more particularly to recognizing gestures using Doppler signals.

### BACKGROUND OF THE INVENTION

The act of gesturing is an integral part of human communication. Hand gestures can be used to express a variety of feelings and thoughts, from emotions as diverse as taunting, disapproval, joy and affection, to commands and invocations. In fact, gestures can be the most natural way for humans to communicate with their environment and fellow humans, next only to speech. It is natural to gesture while speaking.

It is becoming increasingly common for a computerized system to use hand gestures as a mode of interaction between a user and the system. The resounding success of the Nintendo Wii console demonstrates that allowing users to interact with computer games using hand gestures can enhance the user's experience greatly. The Mitsubishi DiamondTouch table, the Microsoft Surface, and the Apple iPhone all allow interaction with the computer through gestures, doing away with the conventional keyboard and mouse input devices.

However, for gesture-based interfaces to be effective, it is crucial for them to be able to recognize the gestures accurately. This is a difficult task and remains an area of active research. In order to reduce the complexity of the task, gesture-recognizing interfaces typically use a variety of simplifying assumptions.

The DiamondTouch, Microsoft Surface and iPhone expect the user to touch a surface, and only make such inferences as might be inferred from the location of the touch, such as the positioning or resizing of objects on the screen. The Wii console requires the user to hold the wireless remote controller, and even so, only makes the simplest inferences that might be deduced from the acceleration of the hand-held device.

Other gesture recognition mechanisms that make more generic inferences can be broadly classified into mouse or pen based input, methods that use data-gloves, and video based techniques. Each of those approaches has its advantages and disadvantages. Mouse and pen based methods require the user to be in physical contact with a mouse or pen. In fact, the DiamondTouch, Surface and iPhone can all arguably be classified as pen-based methods, where the “pen” is a hand or a finger. Data glove based methods demand that the user wear a specially manufactured glove.

Although those methods are highly accurate at identifying gestures, they are not truly freehand. The requirement to touch, hold or wear devices can be considered to be intrusive in some applications. Video based techniques, on the other hand, are free-hand, but are computationally very intensive.

### SUMMARY OF THE INVENTION

A method and system recognizes an unknown gesture by directing an ultrasonic signal at an object making an unknown gestures.

A set of Doppler signals are acquired of the ultrasonic signal after reflection by the object.

Doppler features are extracted from the reflected Doppler signal, and the Doppler features are classified using a set of Doppler models storing the Doppler features and identities of known gestures to recognize and identify the unknown gesture, wherein there is one Doppler model for each known gesture.

### BRIEF DESCRIPTION OF THE DRAWINGS

FIG. 1 is a block diagram of system for recognizing gestures according to embodiments of the invention;

FIG. 2 are timing diagrams of Doppler signals gestures according to embodiments of the invention;

FIGS. 3A-3D are schematic of sample gestures according to embodiments of the invention;

FIG. 4 are box-and-whisker plots displaying the variation in time required to complete a gesture according to embodiments of the invention; and

FIG. 5 is a flow diagram of a method for recognizing gestures according to embodiments of the invention;

### DETAILED DESCRIPTION OF THE PREFERRED EMBODIMENT

Effect of the Invention

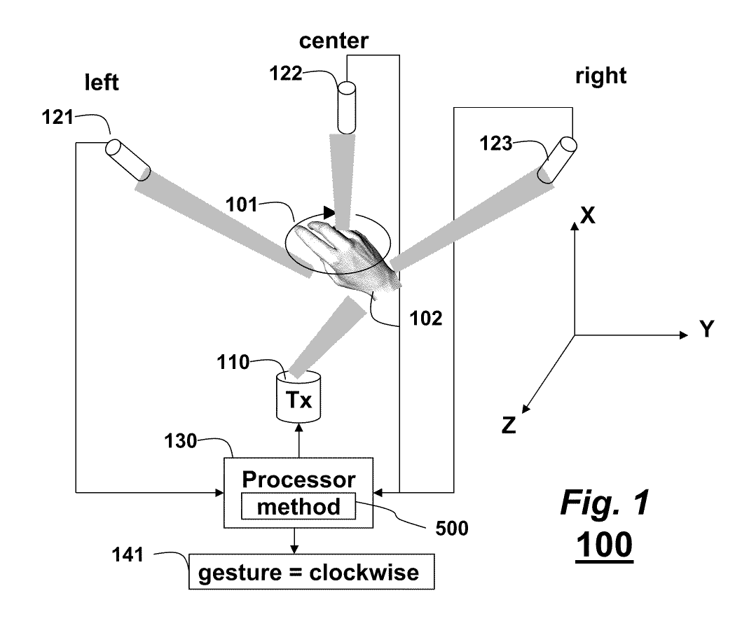

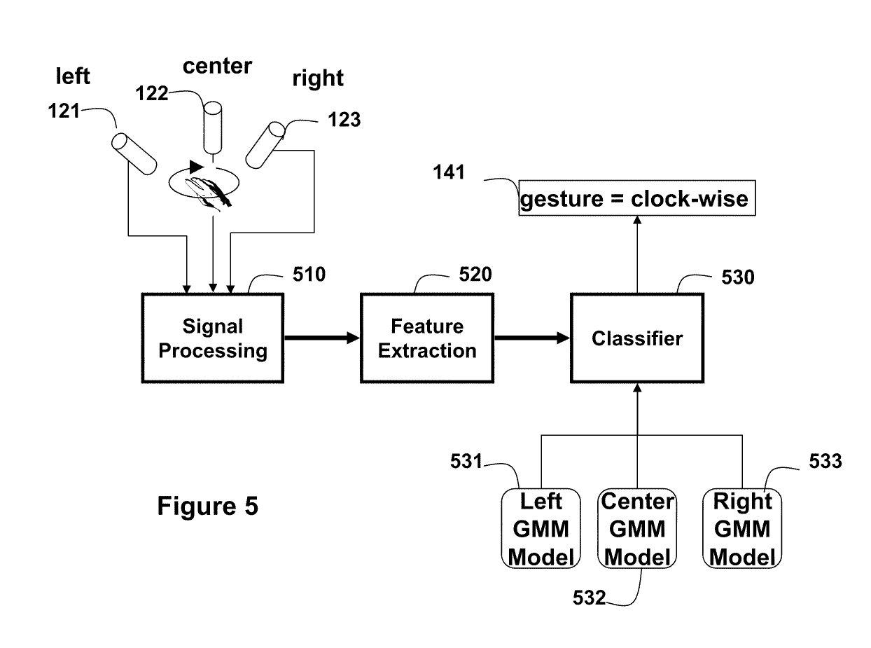

FIGS. 1 and 5 show a system 100 and method 500 for recognizing an unknown gesture 101 of an object, e.g., a hand 102, according to embodiments of our invention. The system includes an acoustic Doppler sonar (ADS) transmitter 110, and a set (three) of ultrasonic receivers (left, right, center) 121-123. The transmitter and the receivers are connected to a processor 130 for performing steps of our method 500.

The transmitter emits an ultrasonic tone that is reflected while the object is gesturing. The reflected tone undergoes a Doppler frequency shift that is dependent on the velocity of the object. The receivers detect the reflected Doppler signals as a function of time. The reflected signals are then used to recognize a specific gesture 141.

The system is non-intrusive as a user need not wear, hold or touch anything. Computationally, the ADS based gesture recognizer is inexpensive, requiring only simple signal processing and classification schemes. The signals from each of the receivers have a low bandwidth and can be efficiently sampled and processed in real time. The signals from the three receivers can be multiplexed and sampled 510 concurrently, thereby reducing the cost of expensive when compared with conventional gesturing devices. Consequently, the ADS based system and method is significantly less expensive than other popular and currently available devices such as video cameras, data gloves, mice, etc. Using simple signal processing 510 and classification 530 schemes, the ADS based system can reliably recognize one-hand gestures.

The ultrasonic Doppler based system used for gesture recognition is an extension of the system described in U.S. Patent Application 20070052578, “Method and system for identifying moving objects using Doppler radar,” filed by Ramakrishnan et al. on Mar. 8, 2007. That system is used to identify a moving object. In other words, that system determines what the object is. We now use similar techniques to recognize gestures, that is, how is the object moving.

The invention uses the Doppler effect to characterize complex movements of articulated objects, such as hands or legs through a spectrum of an ultra-sound signal. The transmitter emits the ultrasound tone, which is reflected by the moving object 102, while making the gesture 101. The reflected signal is acquired by three spatially separated receivers to characterize the motion in three dimensions.

System and Method

As shown in FIG. 1, the receivers are coplanar in the XY plane, and the transmitter is displaced along the Z-axis and centimeters behind the ZY plane. The transmitter is in-line with an orthocenter of the triangle formed by the three receivers. The orthocenter of a triangle is the point where its three altitudes intersect. The configuration of the transmitters and the receiver is specifically selected to improve the discriminative ability of the system.

The transmitter is connected to a 40 kHz oscillator via a power amplifier. The power amplifier controls a range of the system. Long-range systems can be used by users with disabilities to efficiently control devices and application in their environment. The ultrasonic transmitter emits a 40 kHz tone, and all the receivers are tuned to receive a 40 kHz signal with a 3 db bandwidth of about 4 kHz. The transmitters and receivers have a diameter that is approximately equal to the wavelength of the 40 kHz tone, and thus have a beamwidth of about 60°, making the system highly quite directional. The high-frequency transmitter and receiver cost about than one U.S. dollar, which is significantly less than conventional gesture sensors.

The signals that are acquired by the receivers are centered at 40 kHz and have frequency shifts that are characteristic of the movement of the gesturing object. The bandwidth of the received signal is typically considerably less than 4 kHz. The received signals are digitized by sampling. Because the receivers are highly tuned, the principle of band-pass sampling can be applied, and the received signal need not be sampled at more than 16 kHz.

All gestures to be recognized are performed in front of the setup. The range of the device depends on the power of the transmitted signal, which can be adjusted to avoid capturing random movements in the field of the receiver.

Principle of Operation

The ADS operates on the Doppler's effect, whereby a frequency of the reflected signal perceived by the receivers is different from the transmitted signal when the reflector is moving. Specifically, if the transmitter emits a frequency f that is reflected by an object moving with velocity v, with respect to the transmitter, then the reflected signal sensed at the emitter is

f=(vₛ+v)(vₛ−v)⁻¹f,

were vₛ is the velocity of the signal in the medium. If the signal is reflected by multiple objects moving at different velocities, then multiple frequencies are sensed at the receiver.

In this case, the gesturing hand can be modeled as an articulated object of multiple articulators moving at different velocities. When the hand moves, the articulators including but not limited to the palm, wrist, digits etc., move with velocities that depend on the gesture. The ultrasonic signal reflected by the hand of the user subject has multiple frequencies, each associated with one of the moving articulators. This reflected signal can be modeled as

$$d ( t ) = {\sum }_{i = 1}^{N} {a}_{i} ( t ) cos ( 2 π {f}_{i} ( t ) + {φ}_{i} ) + ϒ , \qquad ( 1 )$$

where fᵢ is the frequency of the reflected signal from the i^{th} articulator, which is dependent on vᵢ velocity of the articulator, i.e., direction of motion and velocity, f_{c} is the transmitted ultrasonic frequency (40 kHz), aᵢ(t) is a time-varying reflection coefficient that is related to the distance of the articulator from the receiver, φᵢ is an articulator specific phase correction term. The term within the summation in Equation 1 represents the sum of a number of frequency modulated signals, where the modulating signals ƒᵢ(t) are the velocity functions of the articulators. We do not resolve the individual velocity functions via demodulation. The quantity Y models background reflections, which are constant for a given environment.

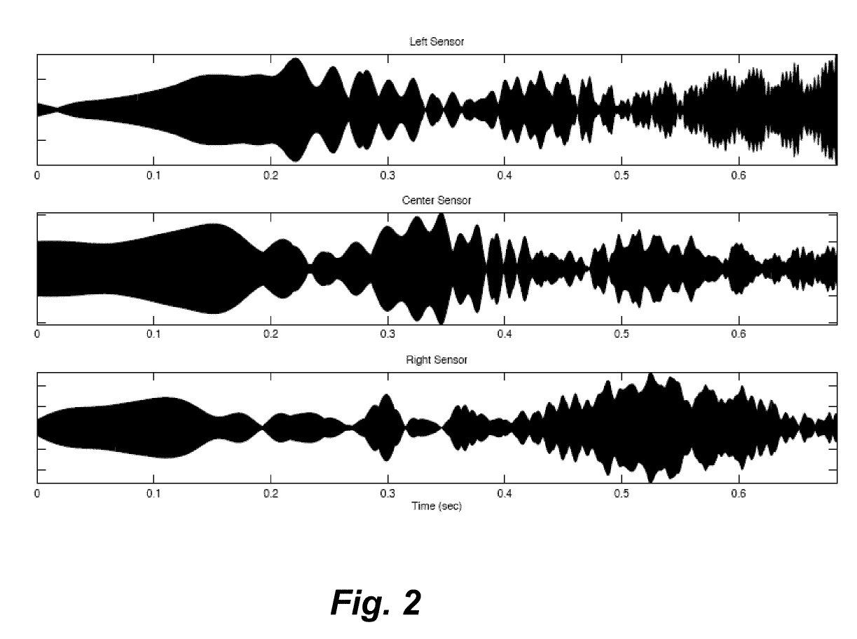

FIG. 2 shows the Doppler signals acquired by the set of receivers. Due to the narrow beamwidth of the ultrasonic receivers, the three receivers acquire distinct signal.

The functions ƒᵢ(t) in d(t) are characteristic of the velocities of the various parts of the hand for a given gesture. Consequently, ƒi(t), and thereby the spectral composition of d(t) are characteristic of the specific gesture.

Signal Processing 510

Three signals are acquired by the three Doppler receivers. All signals are sampled at 96 kHz. Because the ultrasonic receiver is highly frequency selective, the effective 3 dB bandwidth of the Doppler signal is less than 4 kHz, centered at 40 kHz and is attenuated by over 12 dB at 40 kHz±4 kHz. The frequency shifts due to the hand gestures do not usually vary outside this range. Therefore, we heterodyne the signal from the Doppler frequency down to 4 kHz. The signal is then sampled at 16 kHz for further processing.

Feature Extraction 520

Gestures are relatively fast. Therefore, the Doppler also varies fast, and we segment the signal into relatively small frames, e.g., 32 ms. Adjacent frames overlap by 50%. Each frame is Hamming windowed and a 512-point fast Fourier transform (FFT) performed on windowed signal to obtain a 257-point power spectral vector. The power spectrum is logarithmically compressed, and a discrete cosine transform (DCT) is applied to the compressed signal. The first forty DCT coefficients are retained to obtain a 40-dimensional cepstral vector.

Forty cepstral coefficients are determined for the data from each of receiver. The data from all three receivers, I.E., (v_{L}, v_{C}, v_{R}^{∈} [symbol] ^{40×1}, are combined to form a feature vector v=[v^{T}_{L}, v^{T}_{C}, v^{T}_{R}]^{T}, v^{∈} [symbol] ^{120×1}.

The signals acquired by the three receivers are highly correlated, and consequently, the cepstral features are also correlated. Therefore, we decorrelate the vector v using principal component analysis (PCA), further reduce the dimension of the concatenated feature vector to sixty coefficients.

Classifier 530

We use a Bayesian classifier 530 for our gesture recognition. The distribution of the feature vectors obtained from the Doppler signals for any gesture g are modeled by a set of Gaussian mixture models (GMM) 531-533, one for each receiver:

$$P ( v \vert g ) = {\sum }_{i} {c}_{g , i} N ( v ; {μ}_{g , i ,} {σ}_{g , i} ) , \qquad ( 2 )$$

where v is the feature vector, P(v|g) is the distribution of feature vectors for gesture g, [symbol] (v; μ,σ) is the value of the GMM with mean μ and variance σ at a point v, and μ_{g,i}, σ_{g,i}, and c_{g,i} are respectively the mean, variance and mixture weight of the i^{th} Gaussian distribution in the mixture for the gesture g. The model ignores any temporal dependencies between the vectors. The models are independent, and identically distributed (i.i.d.).

After the parameters of the GMM for all gestures are learned, subsequent recordings are classified using the Bayesian classifier. Let v represent the set of combined feature vectors obtained from a Doppler recording of a gesture. The gesture is recognized as a ĝ according to the rule:

$$\hat{g} = {argmax}_{g} P ( g ) {\prod }_{v ∈ V} P ( v \vert g ) , \qquad ( 3 )$$

where P(g) is the a priori probability of gesture g. Typically, P(g) is assumed to be uniform across all the classes of gestures, because we don not make any assumptions about the gesture a priori.

Gestures

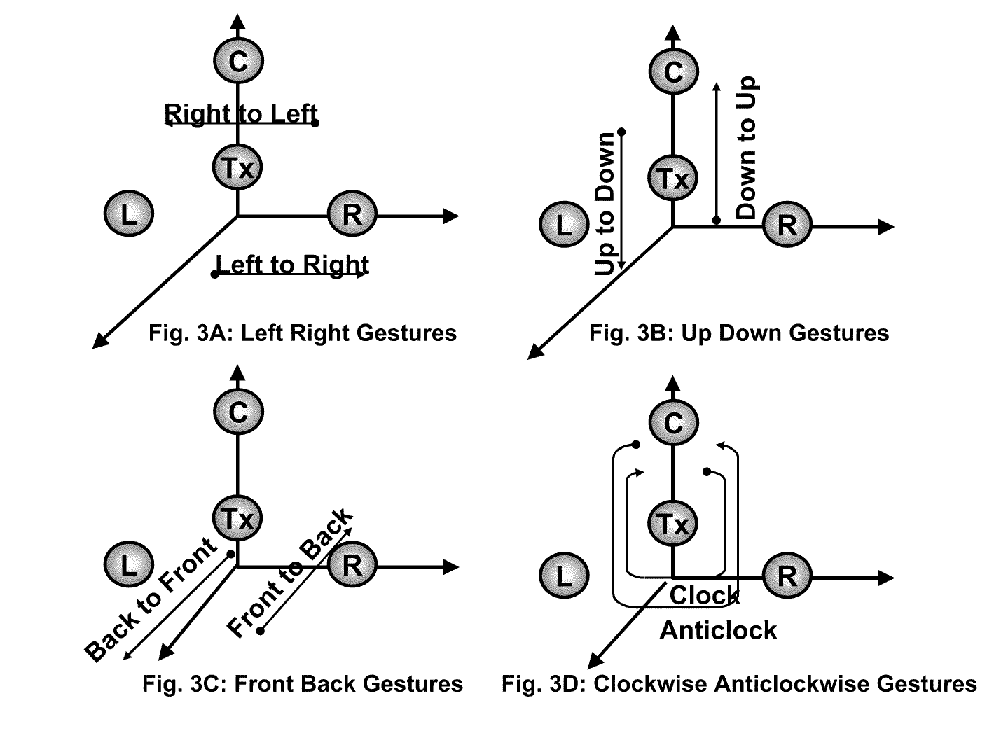

We evaluate our method with eight distinct gestures that can be made with one hand. FIG. 3 shows the actions that constitute the gestures. These gestures are performed within the range of the device. The orientation of the fingers and palm has no bearing on recognition or the meaning of the gesture. The transmitter and receivers are labeled, Tx, C,L, C, and R. The coordinate system is as in FIG. 1.

Left to Right (L2R): This gesture is the movement of the hand from receiver L to receiver R.

Right to Left (R2L): This gesture is the movement of the hand from receiver R to receiver L.

Up to Down (U2D): This gesture is the movement of the hand from base (line connecting receivers L and R) towards receiver C.

Up to Down (D2U): This gesture is the movement of the hand from receiver C towards the base.

Back to Front (B2F): This gesture is the movement of the hand towards the plane of the receivers.

Back to Front (F2B): This gesture is the movement of the hand from the receivers forward.

Clockwise (CG): This gesture is the movement of the hand in a clock wise direction.

Anti-clockwise (AC): This gesture is the movement of the hand in an anti-clockwise direction.

We specifically selected these eight gestures to accentuate, the discriminative capability of our system. For example, the clock-wise movement can be misinterpreted as left-to-right, depending the trajectory taken by the hand.

The configuration of the transmitter and the receivers are determine the operation of the system. Gestures are inherently confusable; for instance, the L2R, R2L, U2D and D2U gestures are the part of the clockwise and anticlockwise gestures. The distinction between these gestures would frequently not be apparent using only two receivers, regardless of their arrangement. It is to overcome this difficulty that we have three receivers that capture acquire and encode the direction information of the hand accurately.

For instance, one of the main differences between the L2R and clockwise gesture is the signal acquired by the receiver C. The L2R gesture takes place in the XZ plane with a constant Y value, which is not the case with the clockwise gesture. This motion along the Y axis is recorded by the C receiver.

The other challenge in recognizing gestures is the inherent variability in performing the gestures. Each gesture has three stages the start, the stroke and the end. Gestures start and end at a resting position each individual can have start and end points. Each user also has a unique style and speed of performing the gesture. All these factors add variability to the data. Gesture time is defined as the time for performing a single stroke.

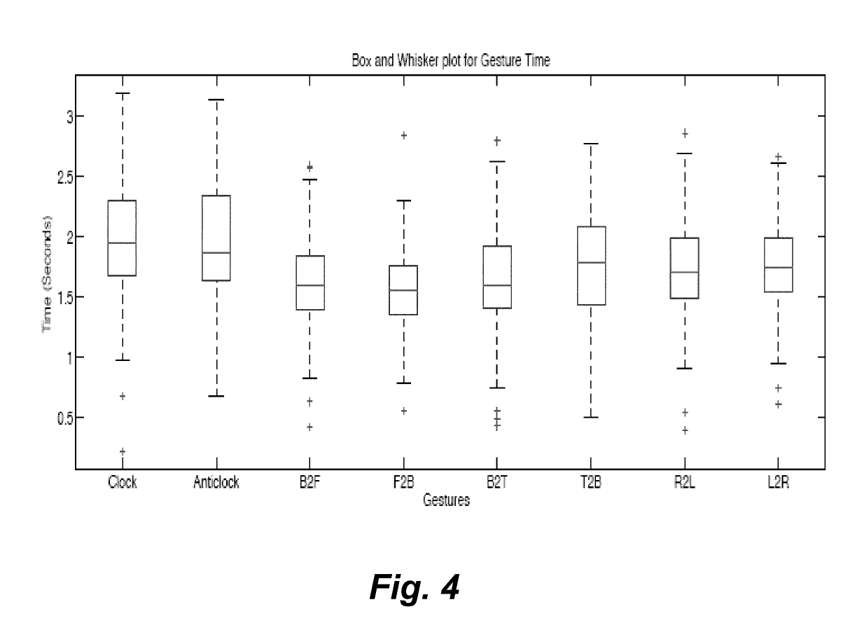

FIG. 4 shows box-and-whisker plots for the various gestures. The plots summarize the smallest observation, the lower quartile, median, upper quartile, and largest observation.

Effect of the Invention

Although the invention has been described by way of examples of preferred embodiments, it is to be understood that various other adaptations and modifications can be made within the spirit and scope of the invention. Therefore, it is the object of the appended claims to cover all such variations and modifications as come within the true spirit and scope of the invention.

We claim:

1. A method for recognizing an unknown gesture, comprising the steps of:
directing an ultrasonic signal at an object making an unknown gestures;
acquiring a set of Doppler signals of the ultrasonic signal after reflection by the object;
extracting Doppler features from the reflected Doppler signal; and
classifying the Doppler features using a set of Doppler models storing the Doppler features and identities of known gestures to recognize and identify the unknown gesture, wherein there is one Doppler model for each known gesture.

2. The method of claim 1, wherein the object is a hand.

3. The method of claim 1, in which the set of receivers include a left, center and right receiver arranged coplanar in an XY plane, and the transmitter is displaced along a Z-axis and centimeters behind the XY plane.

4. The method of claim 1, wherein the transmitter is in-line with an orthocenter of a triangle formed by the three receivers.

5. The method of claim 1, wherein the ultrasonic signal has a frequency of 40 kHz oscillator, with a 3 db bandwidth of about 4 kHz.

6. The method of claim 1, wherein the ultrasonic signal has a beamwidth of about 60°.

7. The method of claim 1, wherein the ultrasonic signal has a frequency f, the object has a velocity v, with respect to the transmitter, and a frequency the Doppler signal is
f=(vₛ+v)(vₛ−v)⁻¹f,
were vₛ is a velocity of the ultrasonic signal in a medium.

8. The method of claim 7, wherein each reflected signal is modeled as
$$d ( t ) = {\sum }_{i = 1}^{N} {a}_{i} ( t ) cos ( 2 π {f}_{i} ( t ) + {φ}_{i} ) + ϒ ,$$
where fᵢ is the frequency of the reflected signal from the i^{th} articulator of the object, which is dependent on vᵢ velocity of the articulator, f_{c} is the transmitted ultrasonic frequency, aᵢ(t) is a time-varying reflection coefficient, φᵢ is an articulator specific phase correction term, and Y models background reflections.

9. The method of claim 1, wherein the features are cepstral coefficients.

10. The method of claim 9, further comprising:
combining the ceptral coefficients into a vector v.

11. The method of claim 9, further comprising:
decorrelating the vector v using principal component analysis.

12. The method of claim 1, wherein the classifying uses a Bayesian classifier.

13. The method of claim 12, wherein a distribution of the vectors is modeled by a set of Gaussian mixture models (GMM), one for each receiver.

14. System for recognizing an unknown gesture, comprising:
an ultrasonic transmitter configured to direct an ultrasonic signal at an object making an unknown gestures;
a set of ultrasonic receivers configured to acquiring a set of Doppler signals of the ultrasonic signal after reflection by the object;
means for extracting Doppler features from the reflected Doppler signal; and
means for classifying the Doppler features using a set of Doppler models storing the Doppler features and identities of known gestures to recognize and identify the unknown gesture, wherein there is one Doppler model for each known gesture.
